(19) United States
(12) Patent Application Publication
(10) Pub. No.: US 2014/0195321 A1
(43) Pub. Date: Jul. 10, 2014

(54) METHOD AND APPARATUS FOR THE ANONYMOUS TARGETED DELIVERY, APPLICATION AND MANAGEMENT OF ELECTRONIC COUPONS AND PROMOTIONS

(71) Applicants: Mark O. Hubbard, South Bend, IN (US); Natalie M. Gunn-Stahl, Mishawaka, IN (US); Courtney E. Parry, Los Angeles, CA (US)

(72) Inventors: Mark O. Hubbard, South Bend, IN (US); Natalie M. Gunn-Stahl, Mishawaka, IN (US); Courtney E. Parry, Los Angeles, CA (US)

(73) Assignee: ZAACHING LLC, South Bend, IN (US)

(21) Appl. No.: 13/999,087

(22) Filed: Jan. 10, 2014

Related U.S. Application Data
(60) Provisional application No. 61/750,886, filed on Jan. 10, 2013.

(51) Int. Cl. G06Q 30/02

(52) U.S. Cl. CPC G06Q 30/0225; G06Q 30/0268
USPC 705/14.26; 705/14.49; 705/14.65

(57) ABSTRACT

A sponsor-agnostic and scalable platform is disclosed that enables websites and point-of-sale terminals to apply targeted offers to anonymous consumers' purchases. Reimbursements to retailers for sponsors' offers are expedited by installing an API (Application Program Interface) at points-of-sale in the retailer's offer network. The API transmits reports and sales data to the platform for respective offer protocols submitted to the platform. The API also sends anonymous registration authentication data entered by a consumer at the point-of-sale to the platform and sends registered consumers' anonymous personae to the retailer's offer network which then supplies eligible offers to the point-of-sale. Alternatively, when sponsors' offer protocols specify which anonymous personae are eligible, the platform may send offers for which a persona of the registered consumer is eligible to the point-of-sale. The fully-implemented platform provides integrity alerts, sales demographics and consumer registration.

This application claims priority from applicants' United States Provisional Patent Application No. 61/750,886 filed on Jan. 10, 2013, which is incorporated herein by reference.

### BACKGROUND OF THE INVENTION

1. Field of the Invention

The invention relates to an electronic platform for the secure distribution, redemption and management of coupons and other promotional offers for products and services to targeted consumers.

2. Discussion of Related Art

Manufacturers, retailers, service providers and sale promotion agencies, rely heavily on paper-based coupon incentive programs, distributing an estimated 330 billion physical coupons annually but achieving only 3.3 billion (1%) coupon redemptions by consumers. To reach a greater number of consumers, especially younger consumers, and to reduce costs, these sellers are implementing electronic coupons (on smart phones or printed from computers), but today only about 2% of all the coupons redeemed are electronic coupons.

Furthermore, conventional methods used to validate, implement and track promotional offers are a time-consuming inconvenience for both the consumer and the seller. Both consumer and seller have to manually collect paper coupons, check them for expiration date, for product specification, for quantity requirements and for any other restrictions placed on the sellers ability to redeem the coupon. However, even many conventional electronic coupons offered by email or on websites, require sellers to collect paper printouts made by the customers' computer systems or attempt to capture a coupon image displayed on a cellphone screen.

For over 120 years, manufacturers have been using coupons to influence consumer behavior. As printing technology developed and consumer acceptance grew, coupons became a method of motivating a purchase, building brand loyalty and test marketing a product. The conventional “free standing insert” (FSI) method of coupon initiation and delivery has remained essentially unchanged, resulting in an increased incidence of fraud.

Coupon fraud has two fundamental variations: 1) a consumer claiming a discount to which they are not entitled, and 2) a retailer claiming a reimbursement by the manufacturer to which they are not entitled. The use of graphic images that can be copied, counterfeited and mishandled, to claim the benefit of promotional discounts makes abuse and financial misappropriation difficult to detect and prevent.

Consumers, and groups allegedly representing consumers, have created credible coupon documents using graphic programs, distributed them electronically, and printed them on high quality laser printers with precision such that they have been honored by retailers at checkout. Because the retailer is liable for the amount of the discount unless reimbursed by the manufacturer sponsoring the offer, even if counterfeits accepted at the checkout counter are later detected by the retailer's management, that retailer may still pass them along to the manufacturer to cover its costs. Because manufacturers are so keen to maintain good relationships with their key retailers, their inclination is to provide reimbursement even when they never actually issued the offer or when the claimed offer is out of date. Such “virtual” promotions are doubly costly to sellers, producing no promotional benefit and poisoning the relationship between retailers and manufacturers.

The retailers, or employees of retailers, who submit coupons to a manufacturer are submitting a claim for cash, escalating the paper coupons they have collected to currency or cash, but there is often no good way to assure that the designated product was actually purchased by any consumer. For example, instead, a checkout clerk may put coupons in the cash drawer and then remove the corresponding amount of cash for his or her personal use. Also, “robo-couponing” by unscrupulous retailers increases sellers' fraud losses exponentially when they clip multiple identical coupons from published sources, such as the out-of-date Sunday newspapers discarded by a local newsstand and then submitting the clipped coupons to the manufacturer for reimbursement, or enabling others to do so.

Coupon fraud is so widespread and prevalent that retailers and manufacturers are extremely reluctant to admit to the scope of this problem and the size of the financial burden it currently imposes on the retail system. Conservative estimates make coupon fraud to be a $500 million problem, just in the U.S. alone. One manufacturer is rumored to have lost over $20 million on one coupon offer for a single product in 2011. Not surprisingly, confirmation of such embarrassing rumors is probably impossible, but it is unquestionably true that coupon fraud is a significant overhead cost that increases consumer prices and reduces retailers' and manufacturers' profits.

Another problem, although it is not inherently fraudulent, is extreme couponing. This stockpiling of large quantities of coupons by a consumer defeats the promotional purpose of issuing coupons and has negative impacts on both manufacturers and retailers. Manufacturers want coupon usage to reach as many potential consumers as possible, and retailers stock shelves to satisfy their customers' anticipated demand for the couponed items. However, extreme couponing allows a single consumer to walk out with large quantities of the promotional item, especially on double coupon days, which leaves the retailer's shelves depleted and the retailer's loyal customers frustrated and dissatisfied. Eliminating such duplication of the offer by the consumer would enable manufacturers and retailers to spread incentives across a larger part of the target market and enable retailers manage the stocking of their shelves to better serve all their loyal customers.

Conventional coupon use and redemption accounting methods have come to disregard fraud, treating it as an inherent cost of doing business. This chronic problem keeps manufacturers and retailers distrustful of each other, while a major purpose of coupons themselves is to build consumer trust. The practical effect of this deep-seated institutional distrust has been to limit the widespread use of coupon-like offers to the products of established, national brands. It also interferes with newcomers' ability to use coupons to build their brand's identity, especially when they need to reach local consumers. Having offer redemption and fulfillment electronically centrally managed through a secure trusted agent would make them useful for building new national brands, and also local and special-purpose brands. Faster, more transparent transfer payments could greatly reduce manufacturers' need to escrow large sums to cover future redemption liabilities and retailers' costs for the “float” they provide while awaiting reimbursement by the manufacturer, providing greater certainty and comfort for both parties.

Coupon incentives are designed to: 1) promote the trial of new products or of existing products by new consumers, and 2) accelerate product sales by incentivizing consumer behavior within a particular span of time or for a specific item type/quantity. Ultimately, manufacturers and retailers offer an amount of value for the consumer that they expect will achieve these outcomes.

The complex operations needed to implement multiple offers from multiple manufacturers that are redeemed in multiple retail outlets are inefficient and produce errors, omissions and outright distrust that cost manufacturers time, dissatisfied customers and waste hundreds of thousands of dollars. That overhead produced by traditional coupon methods reduces the potential value of such promotions to the consumer. There are substantial production, printing, distribution, redemption, accounting and escrow costs. Replacing paper with electronic coupons reduces the physical costs, but not the offer management and fulfillment costs, which are highly variable and difficult to predict.

Having offer redemption and fulfillment electronically and centrally managed through a secure agent can simplify decision making and minimize, if not eliminate, the costly uncertainty and delay produced by the current disjointed, haphazard process of manual clipping, collection and collating them, then finding the product and submitting them to the retailer for redemption who, finally, applies for reimbursement from the offer's sponsor. Centralized processing can provide not only provide faster reimbursement, but quickly cross referencing offers sold, with buyer demographics, retail regions, individual retail locations, time of day and date, etc. supports better decision-making by managers at all levels: manufacturers, franchisors, retailers, agencies, and the rest.

It seems counter-intuitive to attempt to apply a tunneling database design that tracks consumers' cellular phone usage cell by cell and accumulates the fees owed to the service providers in those cells, to reducing consumer resistance to providing the demographic data needed for targeting such promotional offers by centralizing the distribution and management of the targeted promotional offers.

However, although targeted promotional offer platforms have been used by individual retailers, few consumers will take the time to provide those retailers with detailed lifestyle and product preference information needed for efficient offer targeting, even if that retailer is a large, national retailer. Many consumers also consider such survey questions an offensive, mercenary invasion of their privacy. Europe has taken privacy a step further in an outright ban on businesses' practice of sharing consumer contact information. Recent large-scale credit card database breaches have emphasized the importance of anonymity. However, a low-latency, high volume, format agnostic database can cost-effectively and securely centralize and automate anonymous targeting operations in a promotional offer platform network that both protects consumer anonymity and transparently executes offer sales.

Previous promotional offer platforms were retailer-based, and not really targeted, in part because they were not sufficiently scalable to accommodate the diverse, high-volume operations needed to motivate consumers to spend time filing out a detailed consumer survey. Without survey data, consumer profiles built from purchase histories, were too incomplete to be effectively targeted. If they proposed inapplicable items or lacked a sufficient range of products and services then consumers lost interest. On the other hand, if these retailer-based promotional offer platforms were extended to additional sponsors and/or other retailers, the platforms incurred unacceptable costs for reconciling third-party data formats and produced excessive transaction latencies as data volumes increased. If consumers know that no contact information is sought, i.e., that the platform does not enable third parties to flood their post office box with coupons and spam them, but they can anonymously view appropriately targeted offers on-line or on-premises whenever they please, if they please, that removes the privacy concern. Then, if they can access many manufacturers' national coupon-based promotional offers, and diverse retailers' on-premises promotional offer systems without increasing the overall demand on their time after they answer that offer platform's initial consumer survey, taking the time spent answering that survey becomes more profitable for the consumer.

The very size of a large, diverse offer platform built and operated in accordance with the present invention, assures consumers' anonymity. A diverse platform can be independent from the influence of any one individual sponsors and retailers or a small group of them. Also, as a diverse platform, its success hinges on maintaining its reputation for maintaining the security of consumers' personal data and executing targeted offer sales for consumers, not on the patronage of particular subscribers/sponsors. Consumers who take the time to provide detailed preliminary personal information to the offer platform will not recommend the offer platform to others if purchasing the platform's offers is then another tedious process that delays them even further.

In addition to making a very large offer database size substantially transparent to the consumer, the low-latency of the large database used by this platform makes live offer integrity alerts rapidly comparing incoming sales data to stored offer inventory and protocol data available to platform staff. Those live alerts, combined with off-line demographic and geographic information made possible by the detailed data provided in accordance with the invention will decrease the losses conventionally incurred by offers' sponsors as well as allow them to insure that the cost of those offers is benefiting their targeted consumers. For example, sponsors can modify the geographic distribution of a platform offer on the fly, by updating local circuit breaker (CB) limits to focus the promotion on areas where the offered item seems to be less well known, if the detailed live data indicate that is needed.

Finally, the data model agnostic and data format agnostic operations provided by the platform's on-line database in accordance with the invention allows retailers' on-premises SKU# offers to be integrated into that database with manufacturer's UPC# coupon offers, without the delay, costs and risks associated with retailers' manually processing those coupons and submitting requests for reimbursement, but also without extensive format reconciliation. Also, the live data access provided by the platform's high performance data processing system 11b and the live offer sales data automatically transmitted for each sale and automatically monitored by the platform for each subscriber—whether manufacturer, wholesaler, retailer, or promotional agency—for the subscriber's offers sold, at each location where that offer is sold, enables early detection and intervention if and when the problems encountered in conventional electronic and paper coupon distribution promotional programs occur.

Retailers naturally resist any changes to the product promotion process that require substantial capital expenditures from them. Because, although retail is generally a low-margin business, there are ever more types of electronic and paper coupon offers and apparently no way of making the needed changes pay for themselves, the systems retailers use for processing paper coupons and electronic offers have not been upgraded, despite the risks and abuses in the present system. The flexibility provided by a highly scalable platform that broadly shares anonymous consumer information allows the retailers to participate in a stepwise growth of centralized offer sales targeting and monitoring services on their premises. The potential cash advantages to sponsors of the retailers' implementing standardized, central processing and monitoring of the sponsors' targeted promotional offers reduces the likelihood that such recurring capital costs will ever have to be borne solely by individual retailers again. Stepwise introduction of the secure and anonymous offer platform in accordance with the applicants' invention allows all parties to see that the powerful support live data access provides all stakeholders in the management of anonymous but targeted promotional offers, over time, justifies the stepwise costs they are incurring.

Eliminating the processing of paper coupons and “electronic coupon” documents that is so costly and error-prone is an important first step for eliminating coupon fraud, if it enables the real-time monitoring and control needed to attack the coupon fraud problem. In accordance with the invention: 1) live data is used for monitoring offer sales for excessive traffic at any one location or by particular persons; 2) sponsors' reimbursement to retailers is automated and independently centrally monitored to reconcile the volume of sales for each offer item sold with the local shipment and inventory records for that item, and 3) the escrow amount needed from the sponsor to protect retailers who redeem the offer can be reduced as data latency is reduced. For sponsors, the targeted metrics provide early detection of potentially fraudulent behavior and can reduce their escrow burden, as well as improving customer value and encouraging customer loyalty.

Today's infrastructure for the production, distribution, and redemption of traditional paper coupon incentives is expensive, underutilized by consumers and, therefore cost-inefficient for the seller. The industry's continued dependence on the free standing inserts (FSIs) delivered primarily by newspapers and by mail fails to address the dual challenges of maximizing the number of suitable consumers reached and reducing the ever increasing cost of fraud and inefficiency incurred by such promotional programs. A cheaper, more secure and more effective promotional model is needed. The cost of coupons is only justifiable if they help to build a wider base of product experience among consumers, thereby increasing the geographic spread of product awareness and follow-on sales.

### SUMMARY OF THE INVENTION

The present invention provides a method of anonymously providing targeted promotional offers and an electronic offer platform network having a registration authentication engine, an offer protocol engine, and an offer enabling engine that provide an anonymous consumer access to targeted promotional offers while improving accessibility, security, cost efficiency and the scope of the promotional discount offers available to the registered consumer.

Offer protocols submitted by platform subscribers specify anonymous personae that are eligible to receive the subscriber's offer and an offer protocol engine assigns an offer ID to that offer protocol and stores both. In a preferred embodiment, the offer protocol engine also stores display data for each offer submitted by a subscriber in a display data base and the platform enables the display of display data for offers having enabled offer IDs. In a preferred embodiment, the offer protocol specifies items included in the offer and includes a monitoring engine that also stores inventory data for items.

In accordance with the invention, a registration authentication engine verifies that authentication data entered by a consumer matches anonymous authentication data in the platform database having a consumer ID number, and logs in the registered consumer if it does. The platform's offer enabling engine then enables the logged in consumer to access an offer for display or purchase if one of the personae eligible for that offer matches a persona stored with that consumer ID number.

In a particular embodiment, the platform's offer enabling engine enables offers by sending a persona to a subscriber offer network location where the consumer has logged in, and the subscriber offer network supplies one or more enabled offers to the logged-in consumer. In an alternative embodiment, the platform's offer enabling engine enables offers and supplies one or more enabled offers to the platform location where the consumer has logged in.

In a preferred embodiment, the platform includes a point of sale engine and the point of sale engine is enabled to sell an offered item in an offer having an offer ID when a registered consumer logs-in and the point of sale engine receives an enabled offer ID number of an offer protocol that includes that item.

In a preferred embodiment, the platform receives live offer sales data from point-of-sale engines and an offer sales monitoring engine provides offer integrity alerts.

A method in accordance with the present invention registers a consumer on an electronic offer platform by requesting that the consumer enter anonymous authentication and anonymous consumer survey information into the platform. The marketing survey data is sent to the A persona is assigned to the marketing information entered by the consumer in response to the request for marketing information. The anonymous authentication information and the persona or personae assigned to the marketing information entered by the consumer in response to the offer platform's request for authentication information and marketing information are stored by the offer platform. Offers submitted by subscribers are also stored by the offer platform and include customer eligibility profiles. The submitted offers stored by the platform are assigned offer IDs by the platform. Authentication information entered by a consumer into the offer platform is verified by matching it to stored authentication data to log the consumer into the offer platform. The platform enables an offer ID for a logged-in consumer to access an offer if at least one of the logged in consumer's personae satisfies the consumer eligibility profile of that offer.

In one preferred embodiment, the method further comprises the steps of storing display data for each offer submitted by a subscriber in a display data base and enabling the logged in consumer to view display data for an offer having an enabled offer ID.

In another preferred embodiment, the method further comprises the step of enabling the sale of an offered item when the item being purchased by the logged in consumer matches an offered item in an offer protocol having an offer ID number that was received by the point of sale for that logged-in consumer.

In another embodiment, the method includes the steps of monitoring the item volume and offer value of retailers' sales of sponsors' offers and requesting reimbursement of the retailer by the sponsor.

In another embodiment, the method includes the steps of monitoring the item volume of offer sales at respective locations supplied by a given inventory premises and providing an offer integrity alert when the volume of an item sold by locations having respective given location IDs exceeds the inventory of the item at the given premises.

In a further embodiment, the method includes the steps of monitoring the item volume and offer value of items sold at respective locations and providing an offer integrity alert when the value of the promotional offer for an item sold at given location exceeds the value prescribed by the offer protocol for that volume of the promotional offer item sold at that given retail premises.

In a preferred embodiment of the method, a retailer's access to the offer platform can be advantageously stepwise by: 1) installing a ZAACHING™ platform API to expedite reimbursement of the retailer by sponsors; 2) using the ZAACHING™ API to securely and anonymously registering consumers and analyzing their purchases of offers sold by the retailer, 3) installing a ZAACHING™ API to provide demographic analysis of offer sales using the profiles of loyalty program members; and 4) implementing ZAACHING™ integrity alerts and the platform-wide distribution, targeted display and in-depth analysis of all offer sales made by the retailer.

### BRIEF DESCRIPTION OF THE DRAWINGS

The invention will be better understood when the description of preferred embodiments provided below is considered in conjunction with the figures provided, wherein:

FIG. 1 is an diagramatic overview of offer platform apparatus in accordance with a first preferred embodiment of the present invention showing the connections between subscribers' offices, retail premises and e-commerce websites, the offer platform backbone center, and a hosted platform website;

FIG. 1a is a schematic functional block diagram of offer platform apparatus in accordance with a second preferred embodiment of the present invention showing data flows in an offer platform backbone center that includes the platform website;

FIG. 2 is a schematic functional block diagram of a POS terminal in accordance with the offer platform of FIG. 1, in accordance with the invention, in which the POS terminal is a legacy POS terminal that includes API software and in which offers are enabled locally;

FIG. 3 is a flowchart of a method of registering and logging in a consumer to an offer platform in accordance with the invention;

FIG. 4 is a flowchart of a method of registering and logging in a consumer to an offer platform in accordance with the invention;

FIG. 5 is a flowchart of a method of submitting offers, acquiring offer sales data and applying circuit breaker limits using an offer platform in accordance with the invention;

FIG. 6 is a flowchart illustrating the major steps in a preferred sequence of steps by which retailers progressively implement the offer platform of FIG. 1; and

FIGS. 6a-d are copies of the apparatus diagrams in FIGS. 1-2 highlighted to show the features of the offer platform that are sequentially enabled in accordance with the method of FIG. 6.

In these figures, similar items have like index numbers.

### DETAILED DESCRIPTION OF PRESENTLY PREFERRED EMBODIMENTS

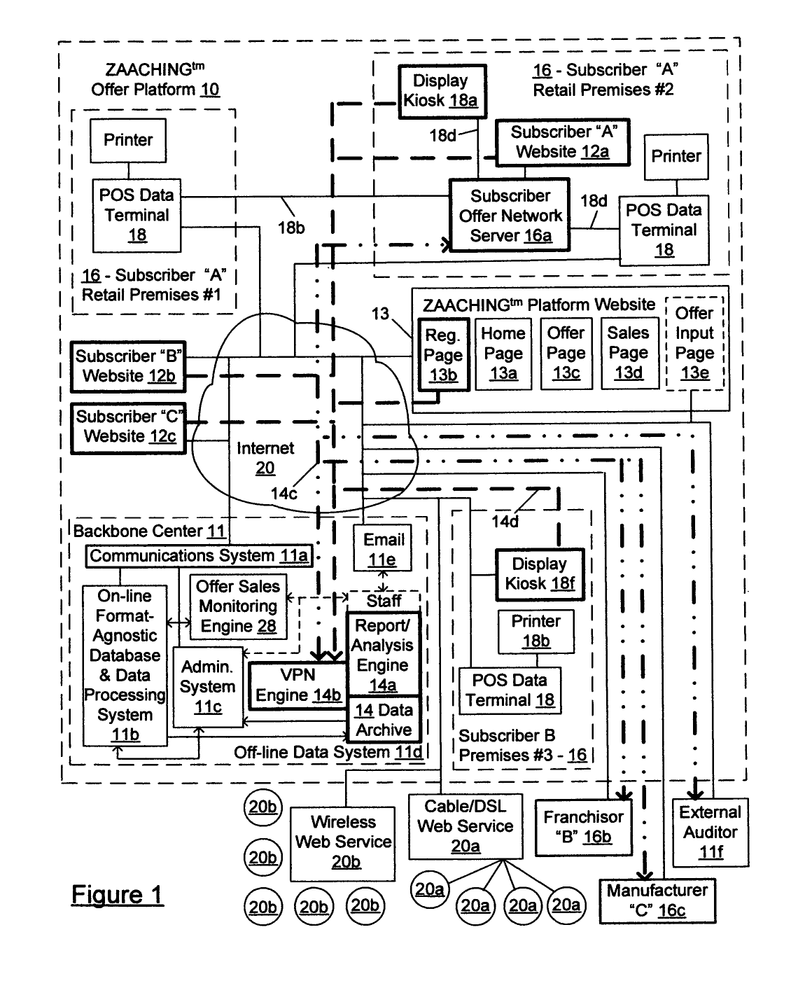

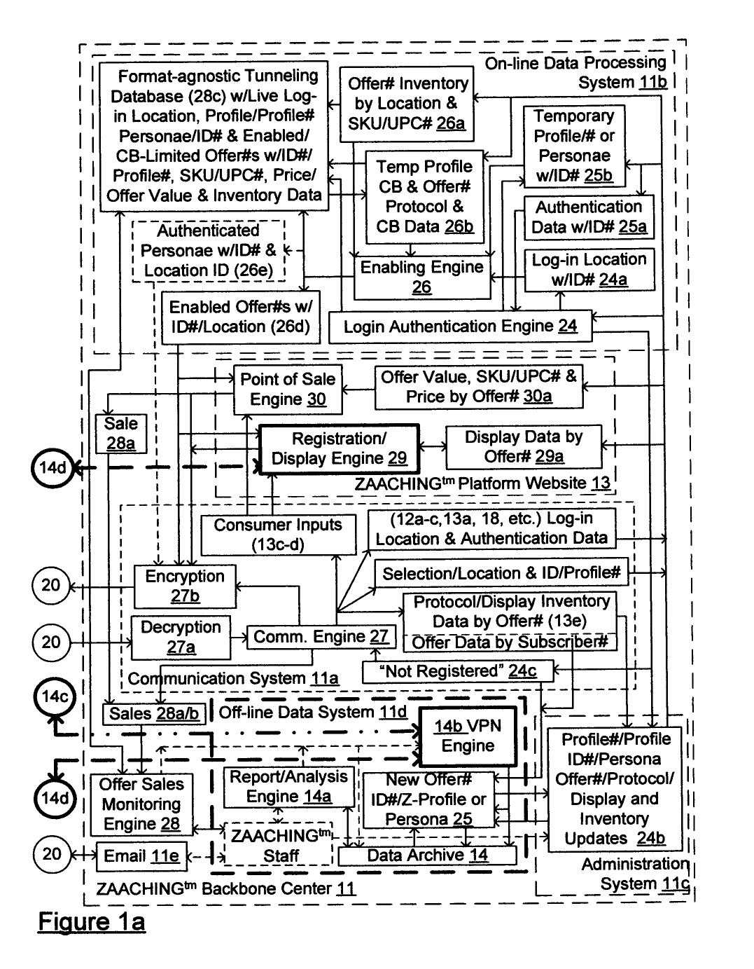

In FIG. 1, an electronic offer platform 10 in accordance with a first preferred embodiment of the invention has a backbone center 11. This platform 10—also referred to hereafter as the “ZAACHING™ platform”—has four major components: the backbone center 11, a ZAACHING™ platform website 13, multiple sellers' own e-commerce websites 12a-c, and also POS (point-of-sale) data terminals 18 and perhaps also electronic offer display kiosks 18a and printers 18b on respective subscribers' retail sales premises 16.

FIG. 1 shows examples of three subscriber premises 16 and websites 12 a-c belonging to three different subscribers A, B and C. All three subscribers 16 and the platform's external auditor 11f have conventional VPN connections 14c through the VPN Engine 14b of the off-line data system 11d used by the staff of the ZAACHING™ Backbone Center 11 for exchanging confidential business information. However, the more personal consumer survey information entered by consumers to initiate or update a consumer's platform registration that governs their eligibility for platform offers is sent from the display kiosks 18a, 18f, and the websites 12a-c and 13 to the VPN Engine 14b of the Backbone Center 11 over a separate, independently encrypted and decrypted VPN channel 14d.

Subscriber A is an example of a retailer such as a supermarket or department store having premises #1 and #2 and a legacy website 12a. The legacy POS data terminals 18 on Subscriber A's premises #1 are connected by a legacy WAN (wide-area network) 18b to the subscriber A's legacy offer network server 18c on subscriber A's premises #2 which processes sales and offer data for Subscriber A's premises. POS data terminals 18 and a legacy advertising kiosk 18a on premises #2 are connected to subscriber A's legacy data processing system 18c by a legacy LAN (local-area network) 18d. However, a consumer survey form that is displayed on the kiosk 18a by an offer platform API installed on that kiosk 18a transmits consumer survey data that is entered using that form to the VPN Engine 14b in the off-line data system 11d of the Backbone Center 11 over the consumer survey VPN channel 14d, and that consumer survey data is not retained in by the subscriber's system.

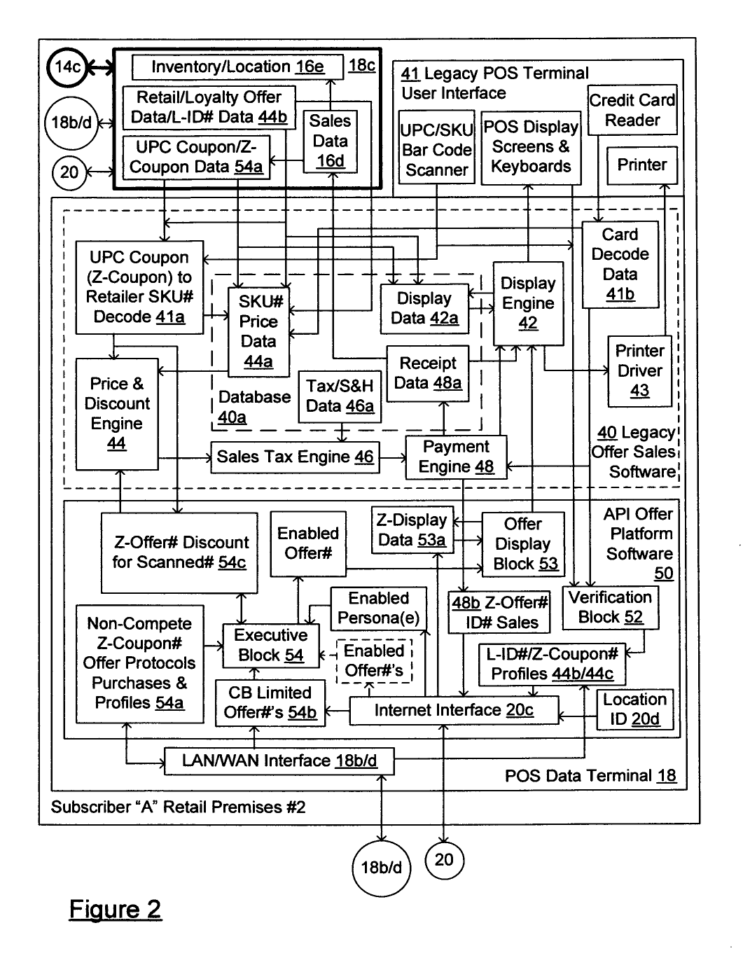

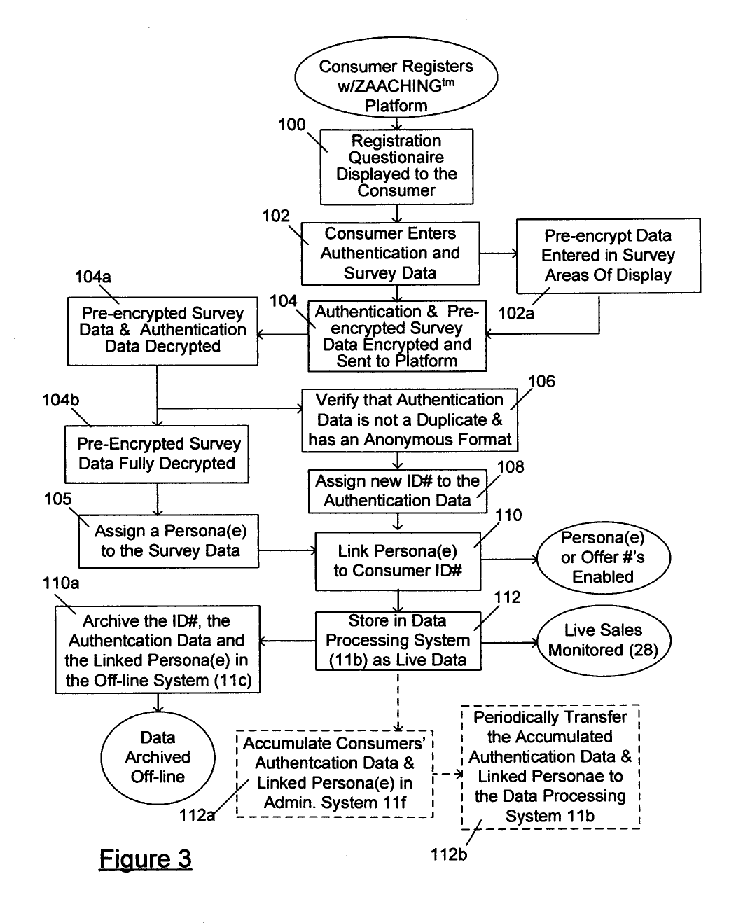

Although all offers for which the persona(e) of a registered consumer are eligible is displayed on the ZAACHING™ website 13, retailers having their own legacy offer platforms, in particular, may prefer that consumers only be shown the retailer's own offers when using kiosks 18a on that retailer's premises 16, except perhaps for a modified version of the ZAACHING™ home page 12a that may still display other offers to promote the global advantages of ZAACHING™ membership. Because the ZAACHING™ platform 10 also implements location-specific CB data 26b that prevents other subscribers' offers from being enabled for that subscriber's locations, rather than receive enabled offer numbers 26d from the backbone center 11, the retailer may request that only the enabled persona 26e and log-in location ID be sent to its locations. Similarly, in a location where data transmission latency or errors unacceptably high a retailer may prefer to have its own offer network server 16a locally enable the platform offer data 26a-b, 29a, that its server has downloaded off-line, and only receive enabled personae 26e from the enabling engine 26, even accumulating enabled personae and the registration authentication data associated with those personae, to reduce the risk that local Internet service problems may hinder its retail operations. For example, in FIG. 2, the Internet interface of the retailer's legacy POS terminal 18a is modified by installation of a platform API module that adapts that device to receive personae and locally enable offer numbers, as shown in FIG. 2.

On the other hand, live sales data must still be sent back to the offer sales monitoring engine 28 for that retail location to receive integrity alerts and to produce centralized, automated requests for reimbursement from a sponsor for that retail location. That sales data must also be sent to the backbone 11 to correctly implement global CB limits that include that retail location. Alternatively, the sales of the subscriber's offers at all other locations, including the platform website 13 must be added in with the subscriber's local offer sales numbers to implement global CB values for the retailer, and integrity alerts and centralized, automated reimbursement requests for that location.

Subscriber B is a franchisor 16b for a service or product such as fast food or tax preparation and has a website 12d that advertises its own platform offers, but does not sell them. Subscriber C is a manufacturer 12c that sponsors platform offers for its products, which are sold through retailers such as Subscriber A. Subscriber C has a website 12c that advertises and sells its own platform offers but it has no retail premises of its own. Subscriber B's franchisees' premises, retail premises #3 for example, have legacy POS data terminals 18 that are connected to the data processing system (not shown) at Subscriber B's headquarters office 12b over a legacy “https” Internet connection, and new offer platform kiosks 18f provided by the franchisor, which can be used by consumers while waiting for service. The new offer platform kiosks 18f and a platform API installed on the websites 12a-c provide a registration form and respective VPN connections 14d that are similar to those provided by the API installed on legacy kiosk 18a.

Like Subscriber A, Subscriber B's franchisees also have both a business confidential VPN connection 14c to the backbone center 11 and a separate consumer survey VPN channel 14d that connects the new offer platform kiosks 18f to the VPN Engine 14b of the backbone 11 for protecting the anonymity of the personae that are assigned to the franchisees' customers using consumer survey registration and update data that the kiosk 18f transmits to the VPN engine in the backbone 11. Subscribers' POS data terminals 18, offer display kiosks 18a, 18e and e-commerce websites 12a-c, also have conventional connections to the ZAACHING™ backbone 11 over the Internet 20 that may be encrypted using Secure Socket Layer (SSL) protocol and Trusted Platform Module (TPM) technology developed by Wave Systems Corporation, for example.

The ZAACHING™ web site 13 shown in FIG. 1 provides webpages 13a-13e, which include a registration page 13b that provides secure VPN encoding and transmission to the VPN Engine 14b in the backbone center 11, of consumer survey data that consumers enter using a consumer survey form that is shown on webpage 13b to initiate and update their registration with the offer platform 10. Data entered in selected areas of the form displayed this webpage 13b is sent to and received by the backbone 11 in doubly-encrypted packets which provide an independent virtual private network (VPN) channel between the backbone center 11 that is schematically represented by the bold dashed lines shown in FIGS. 1-1a. Data entered by the consumer in those selected areas of the form is no longer stored at the display location once the displayed page that includes the consumer survey form is closed.

The ZAACHING™ web site 13 shown in FIG. 1 provides webpages 13a-13e. For consumers who are not registered with the ZAACHING™ offer platform 10, the platform web site 13 has a home page 13a that explains the benefits of its unified, transparent offer platform backbone 11 and displays some examples of offers available to ZAACHING™ consumers who have registered with the platform. Consumers can then enter data on the registration webpage 13b, using whatever Internet-enabled devices 20a, 20b, are available to them.

The registration page 13b first requests anonymous authentication data from the consumer. The anonymous authentication entered by the consumer during registration may include a user name and a password or PIN number (Personal Identification Number) that is chosen by each consumer for logging in to the ZAACHING™ platform 10. The consumer may also add other authentication data to their offer platform registration at any time, for convenience in making offer purchases by, that allow the registered consumer to log in using smart phones, smart cards, credit cards, embedded chips, biometrics such as finger print and facial recognition, the approval of a trusted third party, or any other suitable technique. In particular, if some part of the credit card information that a registered consumer enters to pay for purchases is matched by the platform 10 to authentication data stored by the platform 10, the registered consumer can then be logged in without entering additional data, if that credit card information matches authentication data that is stored by the platform 10. However, of course, the part of the credit card information that is stored by the platform 10 must be selected such that it cannot be used to make a purchase and cannot be used to either identify or contact the consumer.

During registration, each consumer anonymously responds to the consumer survey that is displayed by the platform 10 by entering answers that provide sales demographics and other anonymous marketing data, as shown for example, in Table 1. The platform 10 matches the consumer's survey answers one or more predetermined abstract personae that are available to persona engine 25 from the data archive 14. For example, if each persona includes the consumer's responses to all the survey questions in Table 1, Persona #1 may be a male, head of a household of two persons, English speaking, $50 k-$75 k/year, high school graduate, 35-50 years old, with children, pets, a smart phone, and highly loyal to brands, and Persona #2 may be a female, head of a household of two persons, English speaking, $50 k-$75 k/year, high school graduate, 35-50 years old, with children, pets, a smart phone, and somewhat loyal to brands, etc. A logged-in registered consumer can freely update this at any time there is a change, such as a new baby or a salary increase.

The registration/display engine 29 of the registration webpage 13b provides secure VPN encoding and transmission to the VPN Engine 14b in the backbone center 11 of consumer survey data that consumers enter on the consumer survey form that is shown on webpage 13b, to initiate or update their registration. Data entered in selected areas of the form displayed this webpage 13b is sent to and received by the backbone 11 in doubly-encrypted packets which provide an independent virtual private network (VPN) channel between the backbone center 11 that is schematically represented by the bold dashed lines shown in FIGS. 1-1a. Data entered by the consumer in those selected areas of the form is no longer stored at the display location once the displayed page that includes the consumer survey form is closed.

To view and purchase the discounted items offered by the offer platform website 13 using the offer web page 13c, a consumer first logs in on that web page 13c. The website's display engine 29 then displays the offers enabled for that consumer when the consumer logged in to the platform 10 on that web page 13c. On the ZAACHING™ website, a logged-in consumer can select the products of a particular subscriber, or select a category of offers in which hot deals are displayed to the consumer first. Hot deals' priorities are designated by the owner of the website 12a-c, 13 or kiosk 18a, 18f that displays them under a fee for service contract with the owner of the website 12a-c, 13 or kiosk 18a.

After the consumer selects offers from among the enabled offers being displayed on the offer web page 13c, the sales web page 13d provided by the website's point of sale engine 30 then: 1) calculates the price, offered discount, and total cost of items the consumer selected for purchase on the offer page 13c, using its offer protocol data 30a, 2) arranges for and confirms payment for the purchase in a conventional manner, 3) transmits a copy of the data for that sale to the offer sales monitoring engine 28, 4) sends an email receipt to the consumer, and 5) reports the sale to the sponsor in accordance with the offer protocol submitted either through the communications system 11a or the private webpage 13e.

The private page 13e on the ZAACHING™ website 13 is password accessible to subscribers for submitting their offers to the ZAACHING™ platform 10 or updating those offers, which are processed by the backbone 11 before being posted on the offer webpage 13c. The servers providing subscribers' e-commerce websites 14 may either be physically located on the subscribers' respective premises or may be hosted by an advertising agency, an e-commerce service bureau, an internet service provider (ISP), etc., as is the platform's ZAACHING™ website 13 in FIG. 1

A second preferred embodiment of the ZAACHING™ backbone center 11 that includes the platform's website 13 is shown in FIG. 1a. It has an on-line Internet communications system 11a, an on-line data processing system 11b, a database maintenance administration system 11c, and an off-line data report and analysis system 11d having an off-line data archive 14 that is available to offer platform staff through its data report and analysis engine 14a and available for read-only reference by the engines 25 that assign new customer and offer numbers. The off-line data archive 14 stores confidential subscriber and sponsor information, including detailed historical sales data and highly protected consumer survey information, as well as other platform data. The off-line data archive 14 available to ZAACHING™ staff includes anonymous consumer survey data that is linked to transaction records by the link between the anonymous registration verification data and the registration ID number. The off-line data system 11d also has off-line an email server 11e for use by platform management staff.

The communications system 11a has a communications engine 27 that decrypts 27a the SSL/TPM encryption layer on incoming live offer platform data received from the Internet 20 and encrypts 27b outgoing data. The communications engine 27 also distributes incoming live offer platform data between the on-line data processing system 11b, and the on-line database maintenance administration system 11c according to the format and/or content of the data packets, as is well-known in the art.

The on-line system 11b tracks inventory additions 26a, authenticates log-in data 24, 24a, 25a, and enables personae and offer numbers and also enforces the volume restrictions on offer sales and time/usage limits on temporary ID numbers and temporary personae 26b. Automatic, centralized generation of CB messages is particularly useful to sponsors, to avoid any possible appearance of favoritism among retail outlets, for instance.

In addition to the archive 14 in the off-line data system 11d, platform management staff also have access to live data processed and stored by the on-line data system 11b through the administration system 11c and through an offer sales monitoring engine 28. The offer sales monitoring engine 28 directly receives live sales data 28a, 28b, from the point-of-sale engines 12a-c, 18, and 13, respectively, which it forwards to the on-line data base 28c and also uses to provide live offer integrity alerts to platform staff. The on-line data processing system 11b relies on a specialized type of low-latency, high-volume tunneling database 28c such as the JustOne™ relational database provided by JustOne Database, Inc. of 800 Village Walk #111, Guilford, Conn. 06437, disclosed in United States Patent Application Pub. No. US 2011/0252073 A1. that has heretofore been used to operate cellular telephone subscriber services by allocating wireless communications customers' time and charges to the many cell tower owners used by mobile subscribers in their travels.

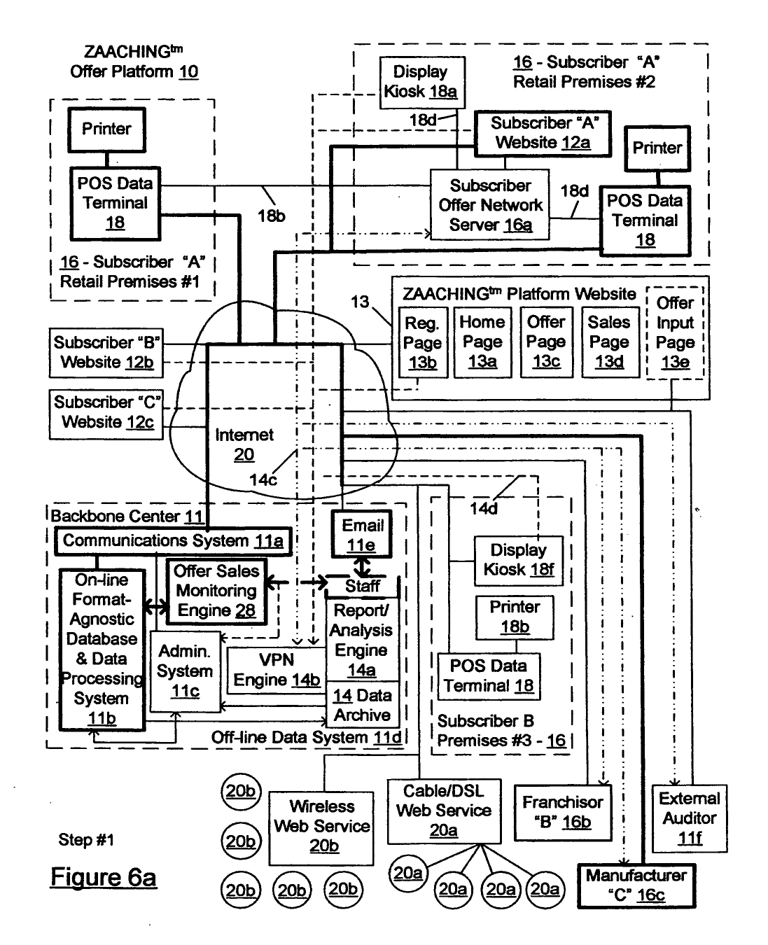

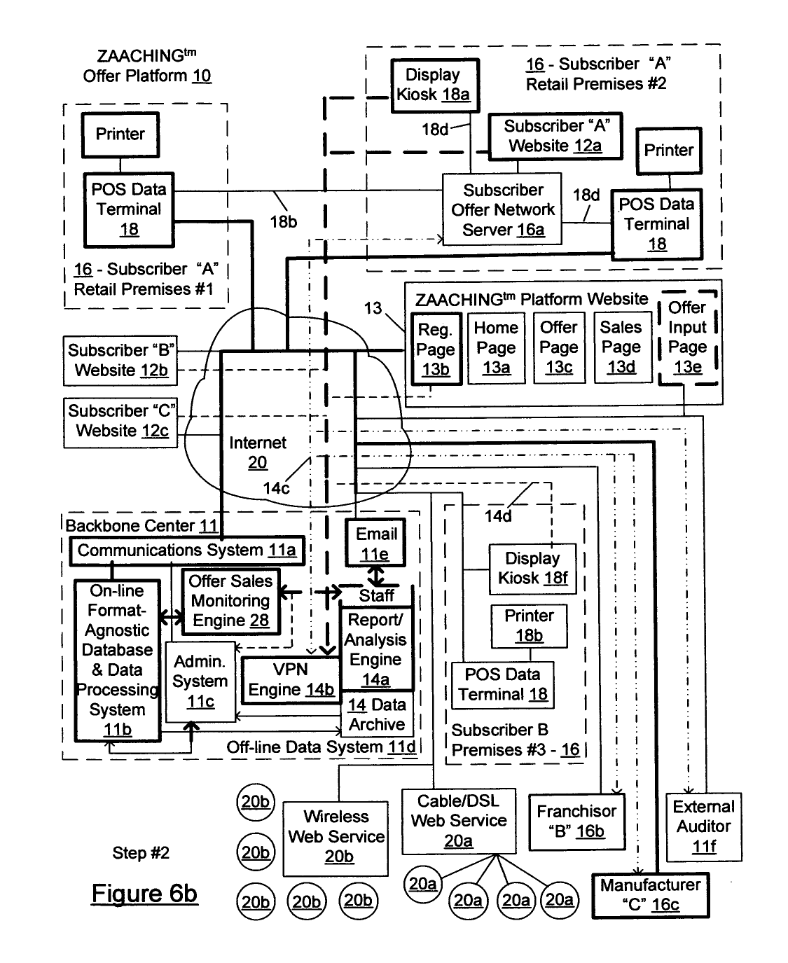

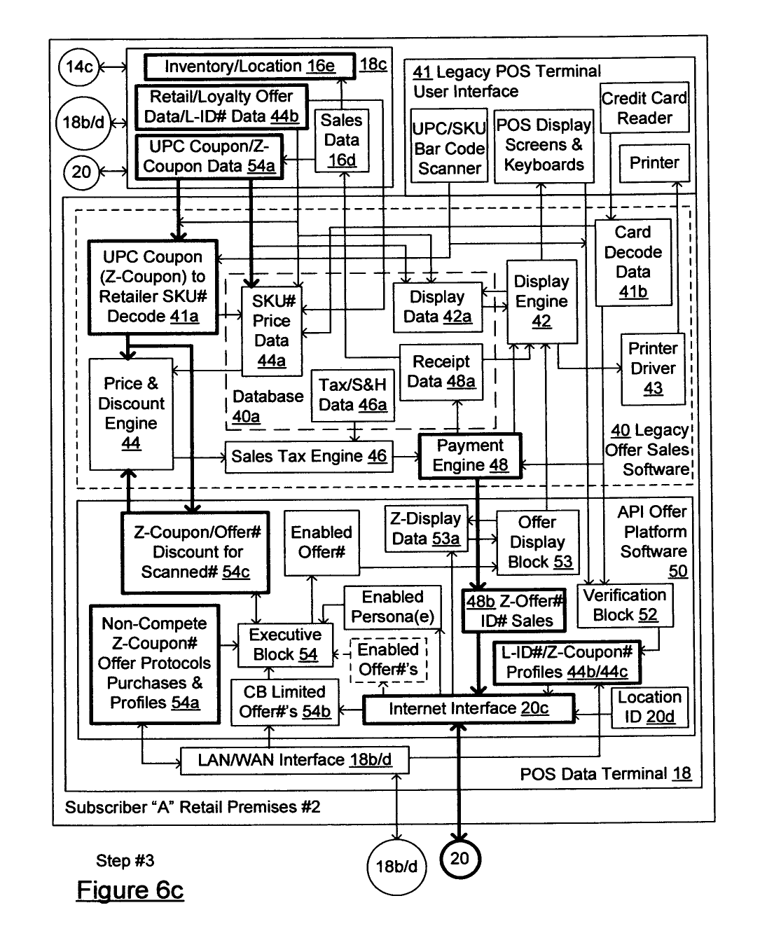

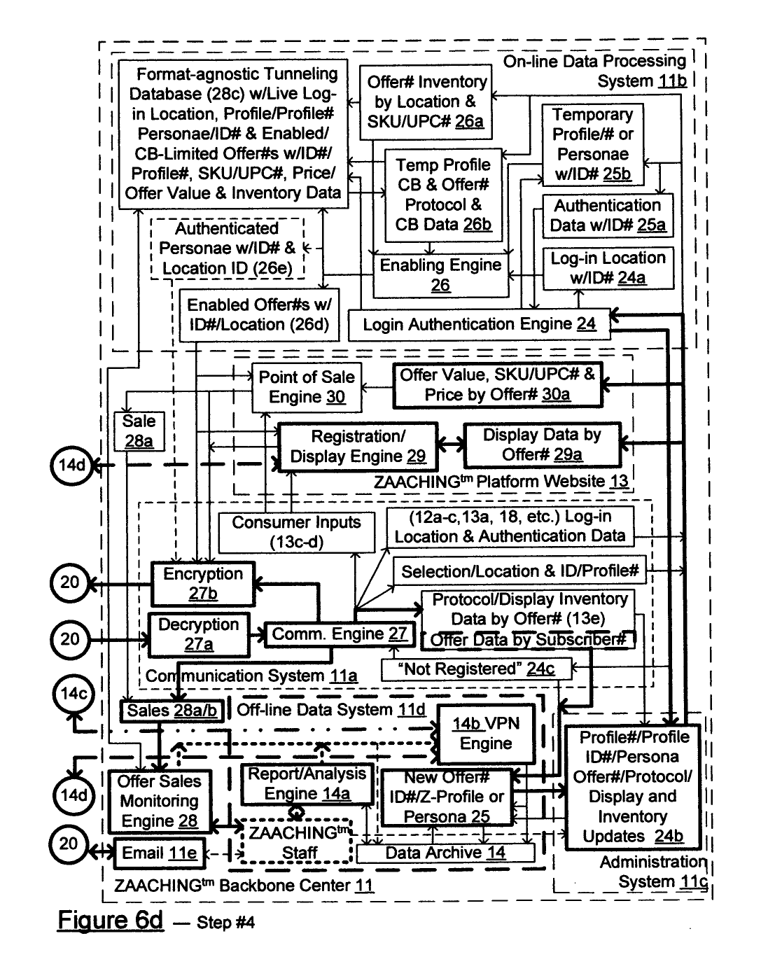

In FIG. 1a, the separate administrative computer system 11c provides live updates to consumer survey and registration authentication data and subscriber offer data in the on-line database 28c if the registration authentication engine 24 in the on-line data processing system 11b finds that login authentication data the consumer, subscriber or the platform staff has entered that matches data found in the on-line database 28c has a registration or subscriber ID number 24b in the on-line database 28c. Once the respective ID number and the format of any new offer data being entered is verified and any changes in the customers consumer profile or persona are made by the respective engines 25, the administration system 11c updates the tunneling data base 28c of the on-line data processing system 11b. Whenever a registration ID or subscriber ID number 24b is not found, the registration authentication engine 24 returns an error message to the log-in location and the off-line data archive 14. If the log in location is the home page 13a of a website 12a-c, 13, or a POS terminal 18 or kiosk 18a, 18f, and if the second consecutive failed attempt to log in using the same registration authentication data also fails, a temporary ID number and profile may be assigned to that registration authentication data if a loyalty card history or a history of previous retail credit card purchases are available from the archive 14 for that registration authentication data. This exception is discussed further with reference to FIGS. 6-6d, below.

Access to live sales data provided in accordance with the present invention improves sponsors' relationships with retailers, by expediting the reimbursement retailers receive for the value of the promotional discounts offered by the manufacturers and franchisors who sponsor those offers. When reimbursement of retailers by a sponsor is automated, the financial “float” they provide to the manufacturer while awaiting reimbursement is sharply reduced. Immediate, automated requests for reimbursement are particularly important to the low margins of pharmacy and grocery retailers. Moreover, direct, automated live monitoring of sales data for the offers available on each website 12a-c and 13, and each retail premises 16 also improves retailers' relationships with the sponsors because this assures that “robo-couponing” and the other types of fraudulent claims for reimbursement of the retailer will be detected reported promptly. Live offer sales reporting improves the administration of all promotional programs that are available at the retailers premises, such as charity donations made on behalf of the customer when specified items are purchased, and scrip or stamps that are issued to customers to provide discounts at other retailers when they purchase the promoted products.

Advantageously, the platform's end-to-end purely electronic offer display and offer purchase processing allows subscribers to specify an automatic “circuit breaker” limits on the duration and/or volume circuit breaker (CB) limits on offer availability to any one persona or any one location and modify them on the fly, as noted above. This encourages purchases in highly competitive locations and locations where a product is less well known, for example, for maximum impact on future sales. The platform's flexible global and/or local circuit breaker limits 26b, 54b, also limit on the money that must be set aside for redeeming a “coupon” offer that can be adjusted in response to changing circumstances. Without paper coupons, coupon printouts or coupon copies the discount can be abruptly terminated at a respective total dollar amount for each SKU# in a particular geographic region or DMA (Designated Market Area), and/or by limiting the total value available to a particular point of sale 12a-c, 13, 16. This improved control of the cost and distribution of promotional offers allows the sponsor to more efficiently allocate the offers and reduces the amount of money that they are legally required to hold in escrow for redeeming each offer. When multiple copies of identical paper coupons or coupon printouts are no longer distributed by the sponsor, then “extreme couponing” is eliminated, which defeats the purpose of product promotions by presenting massive numbers of coupons to one retail premises, exhausting its supply of the offered product, preventing other local customers from buying that product.

Each website 12a-c, 13, and premises 16 selling a sponsor's offer receives both price/volume and offer value sales data, but only for that subscriber's own sales. In the event live volume and offer value sales data from one location causes the offer sales monitoring engine 28 to generate an integrity alert, live sales data from all locations that sell the sponsor's offer is available to platform staff to investigate the event. Price, discount and registration/profile ID number and personae/profile data are all available by point of sale, premises and sponsor, to external auditors 11e in real time for demographic performance monitoring, and financial control and forensic system work. Thus, “robo-couponing” and other abuses of promotional offers can be detected early and discouraged.

FIG. 2 is a schematic block diagram of the legacy POS (point-of-sale) Data Terminal 18 shown in FIG. 1, having conventional check-out-clerk station software 40 and provides an internal POS database 40a and a conventional user interface 41. The user interface 41 provides, among other things, a credit card reader, a barcode scanner that decodes UPC (Universal Product Code) bar code patterns, cash register and credit card reader keyboards, cash register and card reader display screens, and a printer. This user interface 41 and the price & discount engine 44 are supported by UPC coupon to retailer SKU# (Stock Keeping Units) decode data 41a that is updated by the retailer's offer network server 18c over the POS terminal's LAN interface (not shown) with both conventional UPC coupon data to which the offer network server 18c has added Z-coupon data 54a and the retailer's own full-price data and loyalty program offers/membership ID# data 44b, conventional card decode data 41b for the credit card reader, display engine 42 and printer driver 43. The display engine 42 is supported by display data 42a updated by the retailer's offer network server 18c over the POS terminal's LAN interface (not shown) with both the Z-coupon and UPC coupon data 54a and the retailer's own full-price data and loyalty program offers/membership ID# data 44b. The display engine 42, in turn, also supplies display data used by the printer driver 43.

Sales are executed by a legacy price and discount engine 44, sales tax engine 46, and payment engine 48. Sales execution is supported by SKU# price data 44b updated by the retailer's offer network server 18c over the POS terminal's LAN interface (not shown) w/both Z-coupon and UPC coupon offer price data 54a and the subscriber's retail and loyalty price data 44b, sales tax/S&H data 46, and a stored sales receipts 48a that provide the sales data 16d that updates the Z-coupon and UPC coupon data 54a and inventory data 16e for the retailer's offer network server 18c. The display engine 42 is supported by display data 42a in the POS terminal's database 40a. The conventional POS software 40 also includes UPC barcode and credit card decoders 42, 43, a pricing engine 44 that obtains price data for scanned SKU#s 44a from the database 40a for each SKU#. That price data 44a is updated by the retailer's offer network server 18c with conventional third party UPC coupon offer price data to which Z-coupon price data has been added 54a and the retailer's own loyalty offer and membership number data and current full price data 44b. The price & discount engine 44 applies the loyalty offer price when the credit card decoder 41b provides a valid loyalty membership number 44b for a sale. The sales tax engine 46 then accumulates the prices applied by the price & discount engine 44 to the SKU#s decoded by bar code scanner and calculates taxes and fees due on the total sale, the payment engine 48 obtains credit card approvals and generates a sales receipt for the consumer from the POS terminal's printer driver 43 using the display engine 42, stores the receipt data 48a in the terminals database 40a for batch processing by the subscriber, then adjusts the subscriber's inventory and stores coupon sales data Ma in the offer network server 18c in any suitable way well-known in the art.

However, in accordance with a presently preferred embodiment of the invention, in addition to its legacy LAN connection to subscriber's offer network server 18c (not shown) this particular legacy POS data terminal 18 has now been modified by installation of a ZAACHING™ API package that provides an Internet interface 20b that connects the ZAACHING™ API to the ZAACHING™ backbone center 11 without using the subscriber's legacy LAN/WAN communication channels 18b/d in making that connection, and ZAACHING™ API software 50 for the this legacy POS terminal 18 to implement ZAACHING™ offer platform sales, in addition to ZAACHING™ multiple-offer coupon (Z-coupon) sales. Preferably the ZAACHING™ coupon offer #'s 54a assigned by the platform 10 to a subscriber's offers that are sold by the retailer 16 includes the UPC# of the product that is readily decoded by the UPC/SKU decode data 41a into an SKU# assigned by the retailer to the product offered, with added Z-offer ID data.

The subscriber's conventional electronic on-premises display kiosks 18a are modified by similar APIs that provide additional VPN encoding 14d to the consumer survey data used by the persona engine 25 as well as providing an Internet interface 20b that connects the ZAACHING™ legacy kiosk 18a API (not shown) to both the communications system 11a and the VPN engine 14b of the ZAACHING™ backbone center 11, again without using the subscriber's legacy LAN/WAN channels 18b/d in making that connection, Both API-modified POS data terminal 18 shown in FIG. 2, and API-modified kiosks 18a, may receive enabled persona(e) or simply receive enabled offer numbers from the offer platform's backbone center 11. Like the POS terminals, the kiosks also need a user interface 41 that includes a keyboard and display screen to support registration and log-in functions, but with better display screens and graphics for offer display 42 and pricing 44 functions and without the subsequent sales functions. A card reader 43 for log-in and a barcode reader 41a for Z-coupon and UPC coupon offers, are desirable, but a good display screen, good graphics data 16c and an independent VPN channel 14d, or equivalent privacy protection, are essential for the kiosks 18a.

ZAACHING™ API software 50 implements functional blocks that modify the operation of legacy kiosks and POS terminals in accordance with the present invention. These APIs advantageously reduce the cost of implementing the offer integrity alerts, offer analysis, and expedited retailer reimbursement that benefit subscribers and the privacy and convenience the platform offers to their customers and other consumers who registered with the ZAACHING™ platform 10 previously. The more subscribers the ZAACHING™ platform attracts and the better the accuracy of its offer targeting, the more convenience it provides as an automated “personal shopper” for consumers, both on-line and on-premises.

The functional blocks of the ZAACHING™ API software 50 shown in FIG. 2 are analogous to corresponding data processing engines in the backbone center 11. These functional blocks of the API 50 prepare data received from the backbone center 11 and from the POS terminal interface 41 for use by the legacy software 40 of the POS terminal 18 and by the backbone center 11.

If the card reader and its decode data 41b and also the PIN keyboard in the terminal's user interface 41 are used, but the payment engine 48 is not requesting payment, that data is processed by the verification block 52 as potentially being Z- or L-registration authentication data, and any locally-available loyalty or platform data for that potential registration authentication data is forwarded with it and the location ID 20d of the Internet interface 20c of the API 50 to the communications system 11a of the backbone 11. Also, whenever the verification block 52 detects a scanned Z-Coupon bar code, stored profile data used to select that Z-Coupon whfor the consumer of the at data is compared to

The verification block 52 in the ZAACHING™ API software 50 is activated when data is received from the consumer's and from the card reader, or simply from a scanned Z-coupon bar code number. That data is sent by verification block 52 with any loyalty profile data 52 that may be available for that entered data, along with the POS terminal's location ID 20d, through the Internet interface 20c. If that bar code data or card data and PIN data has a persona or Z-profile assigned to it, the enabling engine 26 in the backbone 11 then provides that persona or profile, or the platform offer numbers that it enabled, to the API's location using that location ID 20d. If loyalty 44b or Z-coupon profile data 44c was available, the profile engine 25 converts it to a Z-profile (temporary/partial persona) for use by the enabling engine 26 which provides that persona, or the platform offer numbers that it enables, to the API's location using that location ID 20d. The interface 20c also provides live Z-coupon and Z-offer# sales data. including registration and temp ID #s 48b, through the engine 27 in the communications system 11a of the backbone 11 to the offer sales monitoring engine 28.

Recognizes activation code from the one of the keyboards or a registered partial credit card number is received from the credit card decoder 42 or the bar code scanner, the verification block 52 through the display block 53 which supplies text to the display engine 42 that requests authentication data from the consumer, who may use either the card reader or a keyboard to enter the requested authentication data. The authentication data that is entered on the terminal is sent with location data 20d for that terminal by the verification block 52 in the ZAACHING™ API software 50 to the verification engine 26c in the backbone center 11 over the API's Internet interface 20b. The backbone center 11 may then send: 1) a batch file containing all the enabled offers matched by the offer engine 26 to persona(e) linked to that consumer's log in authentication data and log in location (not shown), or 2) a file containing the logged in consumer's enabled persona(e), to the offer block 54 in the ZAACHING™ API 50. The executive block 54 stores the offers for which the logged in consumer is eligible in the implementation block's working memory 56a until the legacy payment engine 48 records the sale or the consumer's purchase terminates without a sale. Unlike the platform website 12, subscribers will likely prefer that the offers displayed and implemented on their websites 14 and on-premises devices 18, 18a, be limited to the subscriber's offers,

In FIG. 2, the API receives the consumer's enabled persona(e) from the backbone center 11 instead of receiving enabled offer #'s. If the implementation block 56 matches a scanned UPC number to the UPC portion of one of the enabled offer numbers produced by the offer block 54 by matching the persona(e) received from among the offer numbers enabled by the offer block 54, the offer implementation block 56 applies the discount of that matched offer to the item. The offer implementation block 56 preferably implements the offer by listing the local price of all the items, which is provided by the conventional pricing block 44 and a local price data base 44a, and then listing their offer prices and the total discount provided by the implementation block 56 before a conventional sale price for the items purchased is sent to the legacy sales tax engine 46 by the pricing engine 44. After the payment engine obtains payment for the purchase in any suitable conventional manner, the payment engine 48 reports the sales data for that purchase to the POS database 40a in that POS data terminal 40, to the retailer's centralized data processing system 18c and to data archive 14 in the off-line system 11c of the offer platform's backbone center 11.

With reference now to FIG. 3, a new ZAACHING™ customer registers with the offer platform 10 by viewing a registration questionnaire displayed 100 to that consumer by the platform 10 through the consumer's Internet-enabled device 20a on a registration webpage of a website 12 or 14, such as web page 12b, or a similar page displayed by a kiosk 18a on a subscriber's premises 16. The consumer enters anonymous authentication data and anonymous marketing survey data 102 and perhaps also optional contact information requested by the registration webpage.

The registration webpage provided by the consumer's display device pre-encrypts 102a any contact data that may be entered by a new customer in an optional contact data portion of the registration webpage before securely sending all the data the customer entered on the registration webpage to the web server 23 in offer platform's backbone 11, preferably using the SSL security protocol and TPM encryption 104. The Internet communications system 11a sends the anonymous data to the administrative system 11f, which checks whether it is a duplicate or updated registration 106 and matches at least one persona to the survey data 108 and links the persona(e). to the authentication data 110. The update engine 25 accumulates batches of updated data as changes to a copy of the backbone data processor's working files. A copy of that updated copy of the data processor's working registration files is periodically substituted as the working files of the data processor in the backbone 11.

However, a newly registered consumer is logged in as soon as at least one persona is matched for a newly-registered consumer, because the registration engine 24 provides the personae of newly-registered consumers to the verification engine 26c which forwards them to the backbone offer engine 26. The registration engine 24 sends the registration location of the new registration as a log-in location 26d, to the backbone offer engine 26. Thus newly-registered consumers are, in effect, logged in as soon as persona(e) are assigned to a newly-registered consumer, which enables the backbone offer engine 26 to produce either enabled persona(e) or enabled offer numbers, depending on their log-in location 26d.

The pre-encrypted contact data and a copy of the anonymous authentication and survey data is stored by the off-line system 11c in the off-line archive 24b, can be used by the ZAACHING™ backbone center 11 for contacting registered consumers to provide customer service to those registered customers, and to auditors for monitoring the offer targeting performance 116 of the platform 10 in detail, while isolating that information from areas of the backbone center that are accessible to ZAACHING™ subscribers. The off-line computer system 11c is not connected to send data to either the platform's Internet communications system 11b or data processing system 11a.

The administrative system 11c in platform's backbone 11 checks for duplicate entries by that same consumer, for updating stored data, and verifies the entry's format 106. Thus a registered consumer's data is updated, rather than multiplied, if the registered consumer mistakenly re-registers. If format correction is needed, a display provided by the device's display block or website engine requests correction and/or additional information in a conventional way (not shown). The administrative system 11c also matches the marketing survey data that is linked to the authentication data entered by the offer platform's new customer to one or more personae 108 and links that authentication data to the persona(e) 110. The newly registered consumer is then logged in to the platform, and the backbone enabling engine 26 uses the matched persona(e) provided by the authentication engine 24 to provide either enabled persona(e) or enabled offer numbers for the logged-in consumer, depending on the location 26d where they logged in.

Preferably the linked persona(e) and authentication data held by the high performance on-line data base system 11b are updated in real time, rather periodically 112b. Previous large low-latency databases only provided low latency access to data after it was first accumulated and batch processed. Preferably, the update engine 25 in the backbone's administrative system 11c manages registration and offer initiation and updates individually, processing them to eliminate duplicates and verify formalities and, if it is complete and correct, an enabled persona 26e or offer#s 26d is immediately sent out and, depending on the preference of the subscriber who provides the kiosk 18a, 18f, or website 12a-c, 13, used by the consumer are immediately sent to that location so the e consumer who can see and purchase the platforms' offers. The update engine 25 also substitutes old data for new when updates are received.

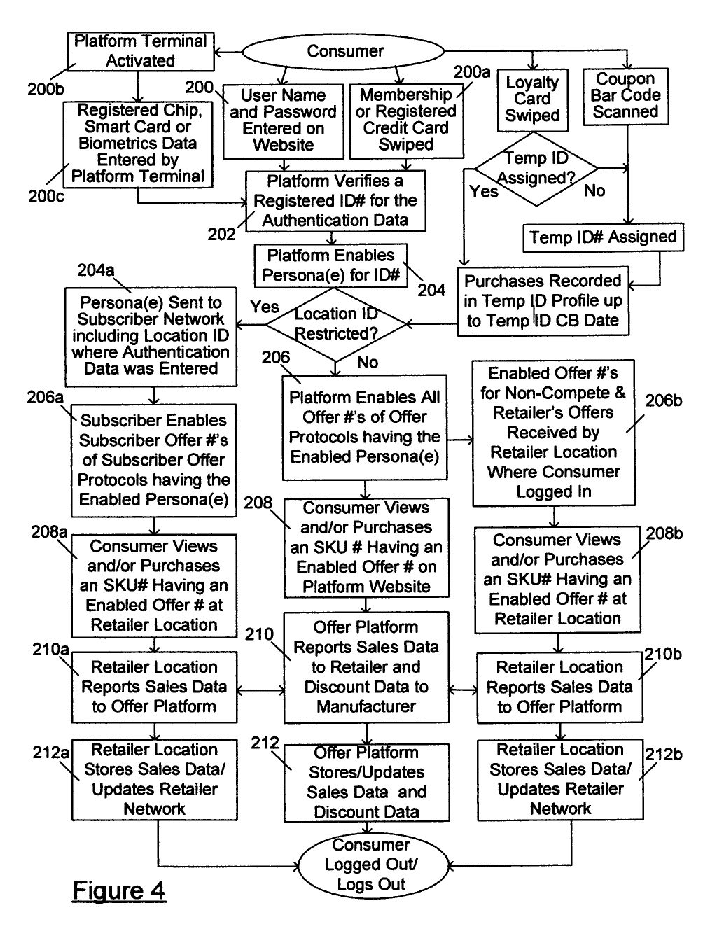

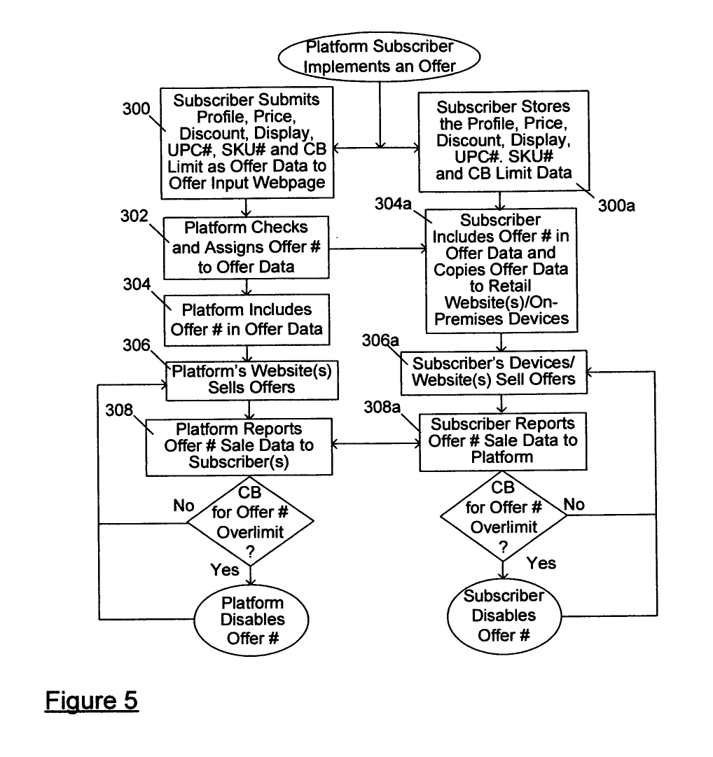

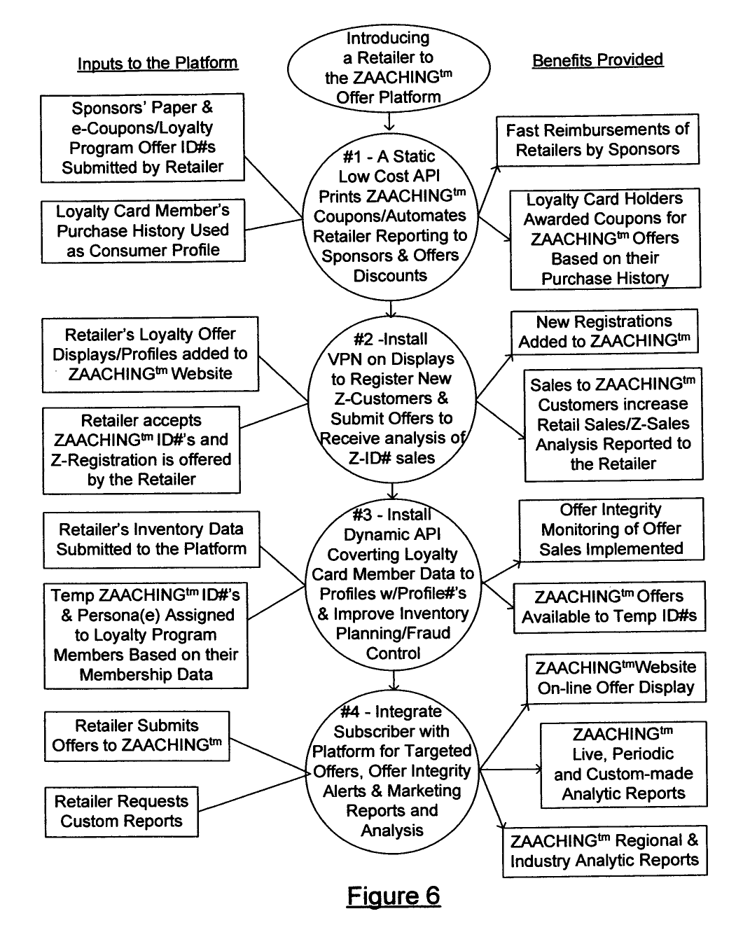

As shown in FIG. 4, a registered consumer can use any type of conventional authentication data that they have previously registered with the offer platform to log in 200a, 200, 200c. In particular, the registered consumer may be prompted by a display at a POS data terminal 18 or kiosk to enter a user name and password on a keyboard, or to swipe or scan a ZAACHING™ membership card 200a. Alternatively, either the consumer or the checkout clerk may enter a code on a keyboard of the POS data terminal 18 that activates 200b the ZAACHING™ API software 50, before entering the authentication data, which may also include a partial credit card number or biometric data such as a thumbprint.

If a registered consumer logs in to the offer platform website 206, on the ZAACHING™ e-commerce web page (13a) all offers enabled for their persona(e) can be viewed (13c) or purchased (13d) 208. If the consumer logs in through a similar log in page provided by a retailer's website 14, or kiosk 18a, only the retailer's offers 206a, 206b, may be accessible 208a, 208b. Whenever the registered consumer logs in on a retailer's premises 16 or by using a retailer's website 12 a-c, the platform 10 may only send the enabled offer IDs of offers that are available at that retail location. Also, customarily, retailers report only discount data, not local retail prices, to offer sponsors. Thus, subscribers who are manufacturers, franchisors or manufacturers' representatives, may prefer to have offer numbers enabled by the backbone center, for uniform offer control and reduce the burden on retailers, but retailers who initiate their own offers may prefer decentralized control, receiving enabled persona(e) from the backbone center 11, as shown in FIGS. 2 and 4. The backbone center 11 archives both price and discount sales data for the offers and provides sales reports and analyses to subscribers in accordance with the reporting protocol established by the subscriber submitting the offer.

As shown in FIG. 5, the offer data submitted to the platform 10 by a subscriber 300 for a new offer is stored by the platform 10, but a subscriber that is a retailer will also store a copy of the offer data for use by their website(s) and/or on-premises devices 300a, if any. That information can be submitted to the platform 10 using the platform's private webpage 12e for subscribers offer input on the platform website 12, as mentioned above, or by email, or in any other suitable way. Subscribers also specify a default reporting protocol (not shown) that directs where real-time offer activity and sales reports are sent, and may provide other protocols for use with particular offers. All offer sales are reported to the platform 10, and the platform 10 reports all sales to the subscriber who submitted the offer.

The offer data submitted to the platform by the subscriber usually includes UPC and/or SKU numbers for the offered item, display, discount, price, customer profile and any applicable circuit breaker (CB) limits. The backbone center 11 checks the offer data for completeness and duplication of other submissions, assigns an offer number to it and sends that offer number back to the subscriber 302. That offer number is then stored with the offer data 304, 304a, and the subscriber distributes that offer data and offer number to its website(s) and on-premises devices 304a, if any. If the subscriber is a manufacturer, either the subscriber or the platform may distribute copies of the offer data and offer number to the retailers that will sell the offer to registered consumers 306, 306a. The CB limits are enforced by the backbone 11, but may also be enforced locally by subscribers that receive enabled personae rather than enabled offers, as is shown in FIG. 2.

The ZAACHING method permits subscribers to add new offers, adjust offers, monitor particular areas that may be subject to potential fraud, adjust to sudden changes in market conditions produced by a hurricane and change circuit breaker limits, all on-the-fly for immediate use. Initiating coupon offers on this the offer platform is analogous to initiating a stock purchase through an electronic stock brokerage system. Since the ZAACHING™ offers can be defined and monitored at a very granular level, they can target a precise demographic, in a targeted market, at a designated retailer's designated address. The offers can also be started and stopped within minutes, using up-to-the-minute sales information, to avoid exceeding available quantities, promotional budgets and other constraints, including even the vagaries of weather conditions and arbitrarily—set limits. Precise market testing of an offer's day-of-the-week, quantity requirement and redemption value dynamics can be conducted by subscribers because the ZAACHING™ offer platform can reliably enforce highly granular test parameters. Two different offers for the same product at the same location could even be randomly assigned to different registered consumers at the same retail premises. That analytical power and flexibility provides added value for both manufacturers and retailers that provides a return on their investment as ZAACHING™ subscribers, assuring that their promotional budgets are efficiently allocated.

FIG. 6 shows a preferred method for the phased implementation the offer platform API on retailers' premises in four steps. The four steps minimize the disruption caused by this integration of conventional operations with the platform's advantageous features, by selectively activating portions of the API. In this way, the retailer's staff and customers are introduced to the program's features in a convenient predetermined sequence and the retailer's previous promotional programs are supported by the platform while new promotional programs that use the platform's features more fully are implemented.

In step #1, shown in FIG. 6a, the ZAACHING™ API software 50 is installed on the retailer's POS terminals 18 and a first portion of the API 50 is enabled. This first portion of that API implements expedited sales reporting to, and reimbursement of the retailer by, manufacturers, franchisors, and other third-party sponsors for the discounts and other promotional programs that they make available to customers at the retailer's premises. This includes charity donations that are made by these third parties for the customer when specified items are purchased, and discount scrip or stamps are issued to customers and/or redeemed by the retailer for those third parties, as noted above. This improved reporting to the sponsors and faster reimbursement of the retailer reduces the cost and risk to the sponsor, and also improves the efficiency of the offers provided by the retailer's own legacy loyalty program promotions.

In step #2, the ZAACHING™ backbone center 11, as shown in FIG. 6a, also periodically send reports of the retailer's promotional sales for each of that retailer's sales premises to that retailer, and provides geographic and market segment analysis of trends in sales and inventory. This can include analysis by POS register and clerk, if misuse of a promotional program is suspected. The retailer also receives demographic analysis of its sales to its legacy loyalty program customers using any demographic data provided by the loyalty program registrations.

At this stage, the customers' demographic data collected by the legacy loyalty program is converted to partial profiles that are reported to the ZAACHING™ backbone center 11. Demographic data for purchases by customers who have already registered with ZAACHING™ elsewhere are included in the demographic analysis. The ZAACHING™ platform also sends regional demographic analysis of each retailer's promotional sales to third-party sponsors of those promotions who are subscribers to the ZAACHING™ platform.

At this stage, the offer profiles for offers provided by the retailer to its customers who are members of its loyalty program are submitted to the ZAACHING™ backbone 11 and are available to ZAACHING™ consumers who have registered with ZAACHING™ elsewhere. ZAACHING™ registration is also offered to the retailer's customers for use both on premises and elsewhere, in place of registration with the retailer's legacy loyalty program.

To introduce customers to the offer platforms great advantage over retailer-specific loyalty programs, Z-coupons for products selected by the retailer but not sold by that retailer, are issued to customer's who have not yet registered with ZAACHING™ when their customer profile for the legacy loyalty program satisfies the ZAACHING™ offer profiles for those products, as shown in FIG. 6b. The Z-coupons are then redeemable for discounts on those other products at ZAACHING™ retailers who sell them.

In step #3, a dynamic ZAACHING™ API enables the ZAACHING™ backbone center 11 to provide demographic analysis of the retailer's loyalty program's offers as shown in FIG. 6c. Reconciling data points between the loyalty profiles and the more detailed personae incurs one time costs, but increases the sample size increases the granularity of reliable results, giving subscriber a taste of the planning tools available with full integration into the platform.

In step #4, full integration enables the subscriber to access the industry wide and regional marketing trend reports, while growing their base of registered consumers.

TABLE 1
An example of Customer Profile Data Points:

A. Gender (male or female)
B. Head of household (yes or no)
C. Size of Household Unit (1, 2, 3, 4-6, 7-9, 10+)
D. Language (English, Spanish, French) (more outside North America)*
E. Estimated Household Annual Income (5 ranges)
F. Education Level Achieved (5 ranges)
G. Age (by calendar year or in typical market demographic ranges)
H. Children in Household (yes or no)
I. Pets in Household (yes or no)
J. Technology Usage (none, computer, smart phone)*
K. Brand Loyalty (none, somewhat loyal, very loyal, exclusive)

Just these very basic data points can provide more than 1,920,000 unique combinations—unique personae. Geographic locators such as DMA, media market, the retailer's store number are also stored by the platform each time the consumer logs in. In this real-time, real data environment, the platform provides exceptional value to subscribers without violating consumers' privacy interests. Items with an asterisk (*) may result in more than one persona per consumer.

What is claimed is:

1. A consumer-access platform network securely and economically providing diverse promotional offers to targeted consumers, said network comprising:
a registration authentication engine for a registration database, said authentication engine providing anonymous registration authentication data for each registered consumer, a respective anonymous registration ID for each registered consumer, and an anonymous persona for each registered consumer to the database, said registration authentication engine being adapted to authenticate the registration of a registered consumer by determining that the registration authentication data supplied to the network from a network location having a respective location ID is registration authentication data that is in the registration database;
an offer protocol engine for a promotional offer database, said protocol engine providing respective offer numbers with the offer data provided by sponsors for their respective promotional offers to the database, said promotional offer data including at least one anonymous persona that is eligible to receive each offer, data identifying at least one item offered by said promotional offer, and the value of said promotional offer for each item offered; and
a promotional offer enabling engine, said enabling engine being adapted to provide a respective promotional offer for which an anonymous persona of the authenticated registered consumer is eligible to the location having the location ID where the registration authentication data was entered.

2. The platform network of claim 1 further comprising:
a registration ID engine adapted to receive registration authentication data from a location in the platform network having a respective location ID when a consumer registers with the platform network, said registration ID engine being adapted to assign a registration ID to said registration authentication data; and
a persona engine adapted to receive consumer survey data over a highly-secure connection from a location having the respective location ID of the location where said registration authentication data was entered, said persona engine being adapted to assign an anonymous persona determined by said consumer survey data to said registration ID,
said registration authentication engine storing said registration ID and said anonymous persona in said registration authentication database, whereby said consumer is registered.

3. The platform network of claim 1 further comprising:
a kiosk, said kiosk being adapted to provide registration authentication data entered by a registered consumer to said registration authentication engine, said kiosk including a display providing offer data to said registered consumer for said offer provided by the enabling engine for which a persona of said registered consumer is eligible.

4. The platform network of claim 3, wherein the kiosk further comprises:
a display providing a questionnaire requesting consumer survey data, said questionnaire being adapted to provide consumer survey data entered by the consumer using the questionnaire to the persona engine over a highly secure connection.

5. The platform network of claim 1, wherein the platform network is connected to at least one point of sale, each point of sale having a location ID, said platform network further comprising:
a point-of-sale engine, said point-of-sale engine being adapted to provide registration authentication data input by a consumer to the registration authentication engine and to receive offer data for a promotional offer for which a persona of the consumer is eligible from said offer enabling engine, said point-of-sale engine executing the sale of an item included in the enabled offer that is selected by the consumer.

6. The platform network of claim 5, wherein the point-of-sale engine is provided by a point of sale terminal.

7. The platform network of claim 5, wherein the point-of-sale engine is provided by a website.

8. The platform network of claim 7, further comprising:
a registration webpage in said website, said webpage displaying a form requesting consumer survey data, said form being adapted to provide the consumer survey data entered by the consumer using the form to the persona engine over a highly secure connection.

9. The platform network of claim 5, said platform network further comprising:
a promotional offer monitoring engine;
a promotional offer sales database, said promotional offer monitoring engine being adapted to cooperate with said point-of-sale engine to provide live sales data to said promotional sales database, said promotional sales database providing said promotional offer monitoring engine low-latency tunneling access to high-volume sales data and offer protocol data including the value of each offer for each item provided by the offer, said promotional offer monitoring engine being further adapted to send a request to the offer's sponsor for reimbursement of the retailer by the offer's sponsor for the value of the offered items sold by the given retailer for the sponsor, whereby reimbursement of retailers for promotional offers sold by the retailers is expedited.

10. The platform network of claim 9, wherein said promotional offer sales database also provides inventory data for inventory locations supplying offer items sold by respective point-of-sale engines to the promotional offer database, said promotional offer monitoring engine being adapted to provide an offer integrity alert when the volume of an item sold by respective points-of-sale exceeds the inventory of the item at the given premises that supplies the item for those points-of-sale.

11. The platform network of claim 9, wherein the promotional offer monitoring engine also is adapted to provide a offer integrity alert when the value of the promotional offer for an item sold at location IDs supplied by the subscriber's premises exceeds the value prescribed by the offer protocol in the for the volume of the promotional offer item sold at that retail premises.

12. The platform network of claim 1, said platform network further comprising:
a profile engine adapted to provide a profile ID number to an anonymous portion of authentication data used by an unregistered consumer to complete a purchase, said anonymous portion of the authentication data being stored by the profile engine as authentication data for a temporary profile ID number; and
a printer engine at a point of sale, said profile engine authorizing the printer engine to print an offer platform coupon for a platform promotional offer item that is suitable for the consumer's purchases.

13. A consumer-access platform network securely and economically providing diverse promotional offers to targeted consumers, said network comprising:
a registration authentication engine for a registration database, said authentication engine providing anonymous registration authentication data for each registered consumer, a respective anonymous registration ID for each registered consumer, and an anonymous persona for each registered consumer to the database, said registration authentication engine being adapted to authenticate the registration of a registered consumer by determining that the registration authentication data supplied to the network from a network location having a respective location ID is registration authentication data that is in the registration database;
a registration ID engine adapted to receive registration authentication data from a location in the platform network having a respective location ID when a consumer registers with the platform network, said registration ID engine being adapted to assign a registration ID to said registration authentication data; and
a persona engine adapted to receive consumer survey data over a highly-secure connection from a location having the respective location ID of the location where said registration authentication data was entered, said persona engine being adapted to assign an anonymous persona determined by said consumer survey data to said registration ID,
a subscriber point-of-sale engine, said subscriber point-of-sale engine being adapted to provide registration authentication data input by a registered consumer to through the on-premises computer network to said promotional computer network registration authentication database engine so as to authenticate said consumer's registration,
a subscriber promotional offer database engine for a subscriber promotional offer database, said subscriber promotional offer database having subscriber promotional offer data for each subscriber promotional offer, said promotional offer data for each subscriber promotional offer including at least one anonymous persona that is eligible to receive said subscriber promotional offer, the offer ID of said promotional offer, data identifying at least one item offered by said promotional offer, and the value of said promotional offer for each item offered,
said subscriber promotional offer database engine being adapted to provide an offer for which an anonymous persona of said authenticated registered consumer is eligible to the platform network when said anonymous persona of said authenticated registered consumer is supplied to said subscriber promotional offer database engine by said registration authentication database engine, and said subscriber point-of-sale engine providing data for each subscriber promotional offer item sold by said subscriber point-of-sale engine to said platform network offer monitoring database, said data including offer item volume, the location ID, value of the promotional offer for each item sold, and the registration IDs of the customers to whom each promotional offer item was sold to said platform network sales database, said platform network providing live, format-agnostic access to the data in said platform network databases.

14. A method of providing promotional offers to anonymous targeted consumers using a platform network, the method comprising the steps of:
providing a consumer survey display to a consumer using a secured connection to the platform network;
verifying the registration of the consumer if registration authentication data entered by the consumer in response to the consumer survey is registered;
providing consumer survey data entered by the consumer using the consumer survey display to the platform network using a highly secure connection;
if the registration of the consumer entering the registration authentication data was not verified, assigning an anonymous registration ID to the registration authentication data entered by the consumer, otherwise, use the use the stored anonymous registration ID that was verified;
if the registration of the consumer entering the registration authentication data was not verified, assigning an anonymous persona to the consumer survey data entered by the consumer, otherwise update the persona stored for the verified registration ID;
providing the registration authentication data entered by the consumer, and a registration ID and an anonymous persona assigned to the consumer to a platform registration authentication database, whereby the unregistered consumer is registered if the registration authentication data was not verified; and
displaying an offer for which a persona of the registered consumer is eligible.

15. The method of claim 15 for providing promotional offers to anonymous targeted consumers using a platform network having an anonymous persona, a registration ID and anonymous registration authentication data stored for a registered consumer, further comprising the steps of:
receiving anonymous registration authentication data entered into the platform network by a registered consumer at a location having a location ID;
verifying that the platform has an anonymous persona stored for anonymous registration authentication data;
enabling the sale of an offer item specified in an offer protocol at a location having the same location ID as the entry of registration authentication data, when a persona of the registered consumer matches a persona in the offer protocol for that offer item; and
executing the enabled sale of the offer item.

16. A method of providing promotional offers to anonymous targeted consumers using a platform network, comprising the steps of:
receiving anonymous registration authentication data entered into the platform network by a registered consumer at a location having a location ID;
verifying that the platform has an anonymous persona stored for that anonymous registration authentication data;
determining that the location of the entry of anonymous registration authentication data made by the registered consumer has a location ID that is included in a subscriber network that is not eligible to receive offers from the platform network; and
providing the anonymous persona stored for that anonymous registration authentication data to the location having the same location ID as the entry of anonymous registration authentication data made by the registered consumer.

17. The method of claim 15 wherein inventory of an item at a given premises supplies the item to platform locations having respective location IDs, by said method further comprising the steps of:
monitoring live volume data for enabled sales of a promotional item executed at respective platform locations having given location IDs, items sold by the respective platform locations being supplied to consumers from inventory of the item at a given subscriber's premises;
comparing the volume of the promotional item sold by locations having the given location IDs to the inventory of the item at the given subscriber's premises, and
providing an offer integrity alert when the volume of an item sold by locations having respective given location IDs exceeds the inventory of the item at the given premises.

18. The method of claim 15 wherein each sponsor's promotional offer protocol includes a promotional value for each item, said method further comprising the step of:
monitoring live value data for the value of the promotional offer for each item in a promotional offer sold at each location having a respective location ID to the platform network with the respective location ID;
comparing the value of the promotional offer for an item in a promotional offer sold at a location having a respective location ID to the value of the offer prescribed by the promotional offer protocol for the volume of the promotional offer item sold at that location; and
providing an offer integrity alert when the value of the promotional offer for an item sold at given location ID exceeds the value prescribed by the offer protocol for the volume of the promotional offer item sold at the given retail premises.

19. The method of claim 15 further comprising the step of:
monitoring live value data for each promotional offer item sold at each location supplied by a subscriber's premises; and
sending a request to the sponsor of a promotional offer from the promotional network for reimbursement of the subscriber having the premises that supplied the sold promotional offer items for the value of the promotional offer for the items sold.

20. A method of implementing a consumer-access platform for targeted promotional offers for a new subscriber, comprising the steps of:
installing a platform API in the subscriber's point of sale engine that provides live offer data from the subscriber's point of sale engine to the platform's offer sales monitoring engine that uses the live sales data to expedite sponsors' reimbursements to the subscriber;
providing a highly secure connection to registration displays so as to enable consumers to securely register with the platform, which enables the platform to analyze offer sales made to more registered consumers;
converting customer purchases into temporary profiles with profile numbers, and submitting subscriber's offer inventory data to supplement analysis of registered consumers' purchases for improved inventory planning and fraud control; and
implementing live offer integrity alerts and submitting subscriber's promotional offers to integrate the subscriber with the platform.
